(19) United States
(12) Patent Application Publication
(10) Pub. No.: US 2025/0058443 A1
(43) Pub. Date: Feb. 20, 2025

(54) TOOL FOR REMOVING A SCREW FROM A RIM AND INTERCONNECTING THE SAME

(71) Applicant: U-CAR INDUSTRY CO., LTD., TAICHUNG (TW)

(72) Inventors: JUNG-HUA CHUANG, TAICHUNG (TW); CHAO-CHING TSENG, TAICHUNG (TW)

(21) Appl. No.: 18/233,890

(22) Filed: Aug. 15, 2023

(51) Int. Cl. B25B 27/02; B25B 23/02

(52) U.S. Cl. CPC B25B 27/023; B25B 23/02

(57) ABSTRACT

A tool includes a nut and a bearing module. The nut is engageable with a screw connected to a spacer to allow a hammer to hit the nut to remove the screw from the spacer. The bearing middle is located between the nut and the spacer to allow smooth rotation of the nut relative to the screw to extend the screw through the spacer, thereby connecting the screw to the spacer.

### BACKGROUND OF INVENTION

### 1. Field of Invention

The present invention relates to a spacer between a rim of a wheel of a vehicle and an axle and, more particularly, to a tool for removing a screw from a rim and interconnecting the same.

### 2. Related Prior Art

A typical car includes two front wheels and two rear wheels. Each of the front and rear wheels is provided with a spacer. The spacers provide room for brakes.

Referring to FIG. 7, a spacer 80 is used with screws 82. The spacer 80 is substantially a disc formed with an internal side facing an axle of a car for example and an external side facing a rim of a wheel of the car. The spacer 80 includes apertures 81. Each of the screws 82 includes a flange located on an internal side of the spacer 80, a ridged section fitted in a corresponding one of the apertures 81, and a threaded section located on an external side of the spacer 80. The ridged section is made with a diameter larger than that of the flange or the threaded section.

In maintenance, a mechanic swings a hammer 87 to hit the threaded section of one of the screws 82 to remove the ridged section of the same from the corresponding aperture 81. Thus, the ridged section of a new screw 82 can be fitted in the corresponding aperture 81. However, the use of the hammer to hit the threaded section of such a screw is not precise and might damage the spacer 80. Moreover, the use of the hammer to hit the threaded section of such a screw to remove such a screw is inefficient.

An installing unit can be used to connect the new screw 82 to the spacer 80. The installing unit includes a bearing module and a nut. In use, the bearing module is in contact with the external side of the spacer 80. The threaded section of the new screw 82 is extended through the corresponding aperture 81 from the internal side of the spacer 80. The nut is engaged with the threaded section of the new screw 82. The nut is rotated relative to the threaded section of the new screw 82 to insert the ridged section of the same deep into the corresponding aperture 81 toward the external side of the spacer 80 from the internal side of the spacer 80. Finally, the flange of the new screw 82 is in contact with the internal side of the spacer 80. The bearing module allows smooth rotation of the nut relative to the spacer 80.

The present invention is therefore intended to obviate or at least alleviate the problems encountered in the prior art.

### SUMMARY OF INVENTION

It is the primary objective of the present invention to provide a precise and efficient tool for removing a screw from a spacer and connecting the screw to the spacer.

To achieve the foregoing objective, the tool includes a nut and a bearing module. The nut is engageable with a screw connected to a spacer to allow a hammer to hit the nut to remove the screw from the spacer. The bearing middle is located between the nut and the spacer to allow smooth rotation of the nut relative to the screw to extend the screw through the spacer, thereby connecting the screw to the spacer.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a spacer, screws and a tool in a disconnecting mode according to the preferred embodiment of the present invention;

FIG. 2 is an enlarged perspective view of a portion of the spacer, one of the screws and the tool shown in FIG. 1;

FIG. 3 is a perspective view of the tool in another position relative to the spacer and the screw than shown in FIG. 2;

FIG. 4 is a cut-away view of the tool, the spacer and the screw shown in FIG. 3;

FIG. 5 is an exploded view of the tool in a connecting mode;

FIG. 6 is a cut-away view of the tool shown in FIG. 5; and

FIG. 7 is a perspective view of a spacer and screws.

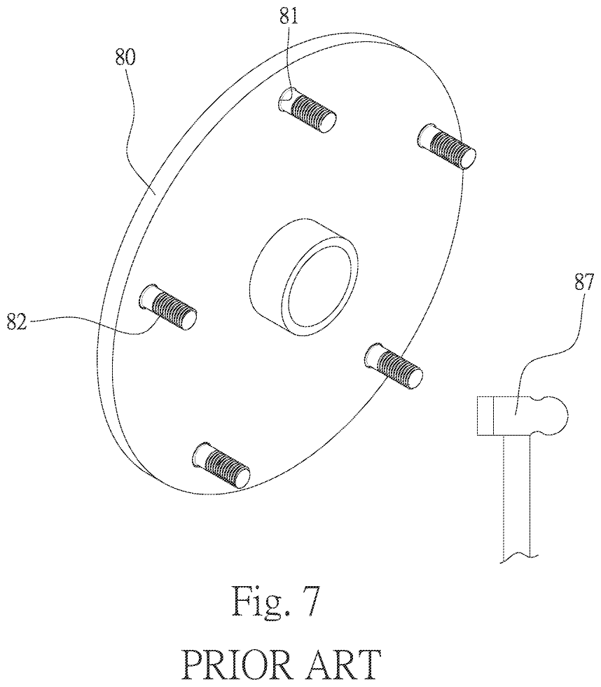

### DETAILED DESCRIPTION OF PREFERRED EMBODIMENT

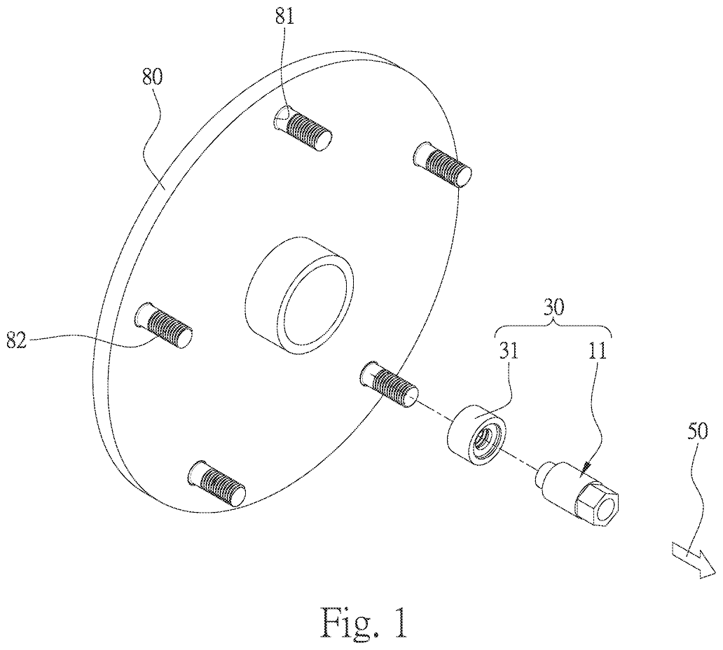

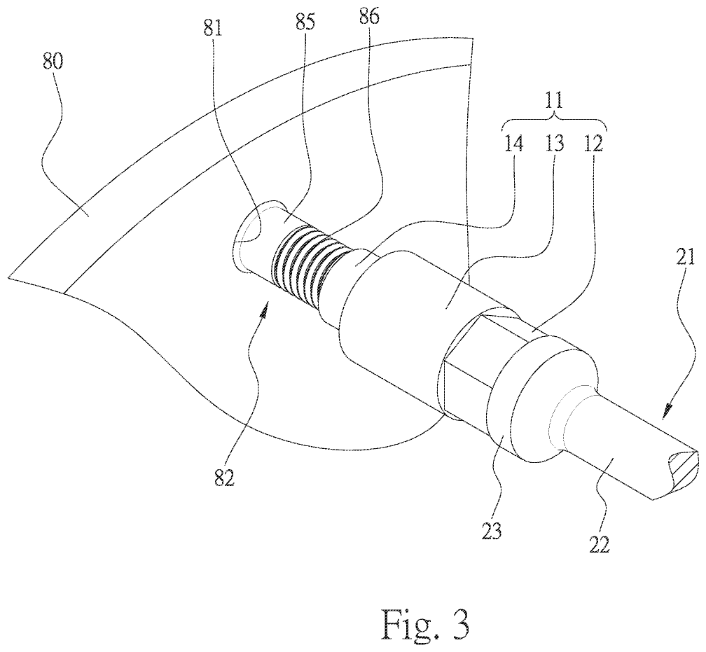

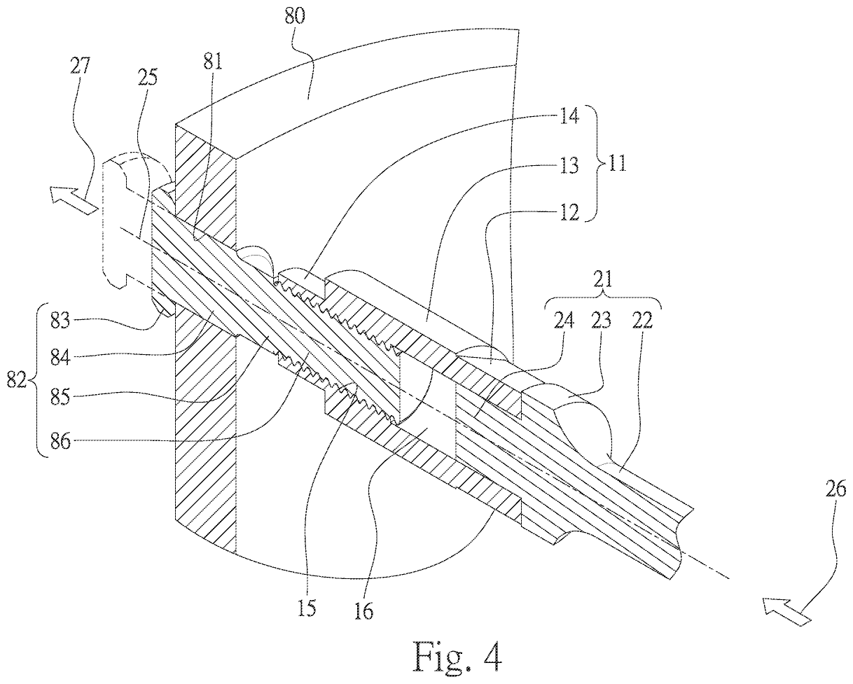

Referring to FIGS. 1 through 6, a spacer 80 is used with five screws 82. The spacer 80 includes five evenly-distributed apertures 81. Each of the screws 82 includes a flange 83 at an end, a ridged section 84 extending from the flange 83, a reduced section 85 extending from the ridged section 84, and a threaded section 86 extending from the reduced section.

In use, the flange 83 of each of the screws 82 is in contact with an internal side (not shown) of the spacer 80, the ridged section 84 is fitted in a corresponding one of the apertures 81, and the reduced section 85 and the threaded section 86 are located on an external side of the spacer 80. The ridged section 84 of each of the screws 82 prevents the screw 82 from rotation relative to the spacer 80.

Referring to FIG. 1, a tool includes a nut 11 and a bearing module 31 according to the preferred embodiment of the present invention. The nut 11 is used alone as a screw-removing unit to remove the screws 82 from the spacer 80. The nut 11 and the bearing module 31 are used as an installing unit 30 to connect the screws 82 to the spacer 80 in a direction indicated by an arrow head 50.

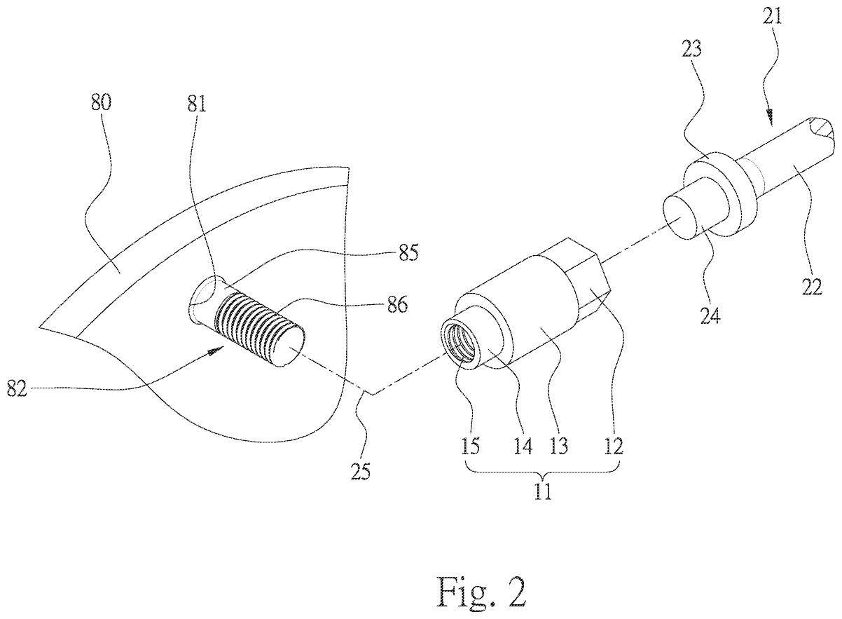

Referring to FIGS. 2, 3 and 4, the nut 11, the spacer 80 and only one of the screws 82 will be described. The nut 11 is used with a hammer 21 to remove the screw 82 from the spacer 80.

The nut 11 includes a polygonal section 12, an enlarged section 13, a reduced section 14, a screw hole 15 and a bore 16. The polygonal section 12 is formed at a first end of the nut 11. The polygonal section 12 is made with a diagonal considerably larger than a diameter of the screw 82 so that it is much easier to use a hammer to hit the polygonal section 12 of the nut 11 than hit an end of the screw 82. Preferably, the polygonal section 12 is a hexagonal section. The bore 16 is made in the first end of the nut 11. The reduced section 14 is formed at a second end of the nut 11. The screw hole 15 is made in the second end of the nut 11. The enlarged section 13 is formed between the polygonal section 12 and the reduced section 14. In diameter, the enlarged section 13 is larger than the reduced section 14. The polygonal section 12, the enlarged section 13, the reduced section 14, the screw hole 15 and the bore 16 extend along an axis 25 of the nut 11. Preferably, the screw hole 15 is in communication with the bore 16. In another embodiment, the screw hole 15 is separated from the bore 16.

The hammer 21 is part of an automatic tool. The automatic tool reciprocates the hammer 21 in operation. The hammer 21 includes a rod 22 at an end, an insert 24 at another end, and an enlarged section 23 between the rod 22 and the insert 24. Such automatic tools can be seen in Taiwanese Patent Nos. M534076 and I453098 and U.S. Pat. Nos. 6,962,211, 7,523,791 and 7,886,838.

The nut 11 is engaged with the screw 82, i.e., the screw hole 15 of the nut 11 receives the threaded section 86 of the screw 82. The insert 24 is inserted in the bore 16. The enlarged section 23 of the hammer 21 is abutted against the polygonal section 12 of the nut 11. The automatic tool is turned on to drive the enlarged section 23 of the hammer 21 to repeatedly hit the polygonal section 12 of the nut 11 in a direction indicated with an arrow head 26, thereby removing the ridged section 84 of the screw 82 from the corresponding aperture 81, i.e., removing the screw 82 from the spacer 80 in a direction as indicated with an arrow head 27. Then, the nut 11 is disengaged from the screw 82.

As described above, the nut 11 is an intermediate element between the screw 82 and the hammer 21 of the automatic tool. The automatic tool is operable to drive the hammer 21 to precisely and efficiently hit the screw 82 via the nut 11.

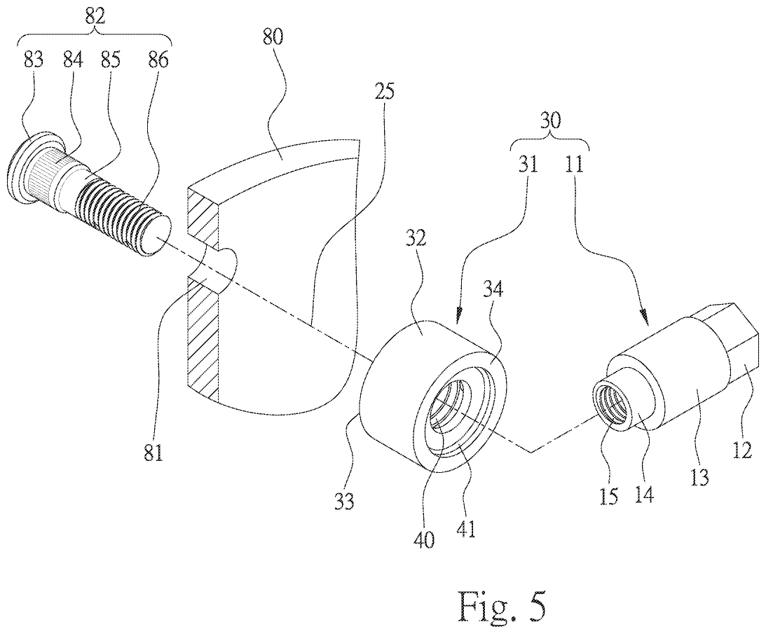

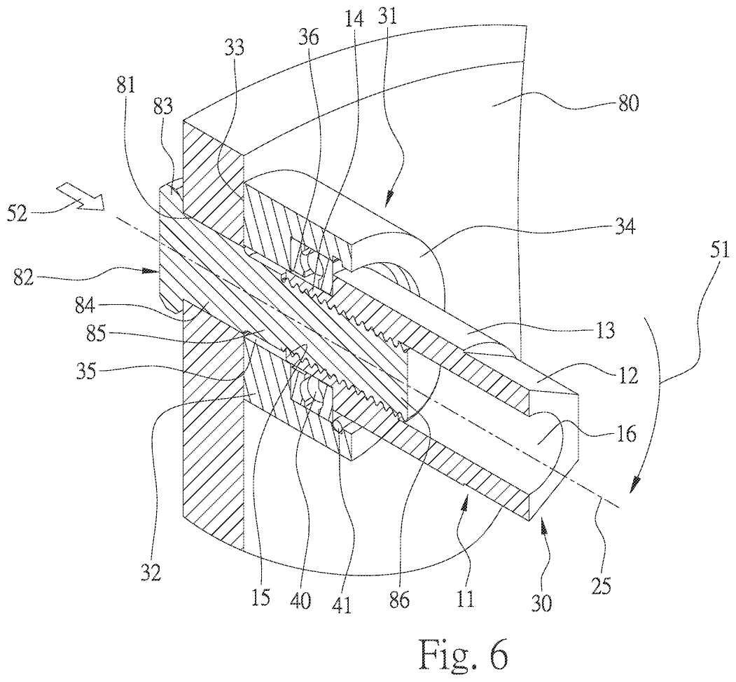

Referring to FIGS. 5 and 6, the bearing module 31 includes a shell 32, a bearing 40 and a clip 41. The shell 32 includes a front face 33, a rear face 34, an aperture 35 in a front face 33, and a chamber 36 in the rear face 34. The aperture 35 is in communication with the chamber 36. A diameter of the aperture 35 is smaller than that of the chamber 36, thereby forming a shoulder between the aperture 35 and the chamber 36. Preferably, the aperture 35 is in communication with the chamber 36.

The bearing 40 is inserted in the chamber 36. Preferably, the bearing 40 is a ball bearing.

A clip 41 is used to keep the bearing 40 in the chamber 36. To this end, an external portion of the clip 41 is inserted in a groove (not numbered) in a wall extending around the chamber 36, and an internal annular portion of the clip 41 is abutted against the bearing 40. Preferably, the clip 41 is a C-clip.

To connect the screw 82 to the spacer 80, i.e., to insert the ridged section 84 of the screw 82 in the apertures 81 of the spacer 80, the threaded section 86 is extended through the aperture 81. The threaded section 86 is extended through the bearing 40, which is kept in the shell 32. The nut 11 is engaged with screw 82, i.e., the screw hole 15 of the former receives the threaded section 86 of the latter. In a direction indicated by an arrow head 51, the nut 11 is rotated relative to the screw 82, which is not allowed to spin relative to the spacer 80 due to adequate friction between the ridged section 84 of the screw 82 and a wall of the aperture 81. Thus, the ridged section 84 of the screw 82 is moved into the aperture 81 in a direction indicated by an arrow head 52. The bearing module 31 is operable to render the rotation of the nut 11 relative to the screw 82 and the spacer 80 smooth. The reduced section 14 of the nut 11 is inserted in a central aperture (not numbered) made in the bearing 40. Finally, the ridged section 84 of the screw 82 is located in the aperture 81 of the spacer 80. The reduced section 85 of the screw 82 is located in the aperture 35 of the shell 32. The threaded section 86 of the screw 82 is inserted in the screw hole 15 of the nut 11. The reduced section 14 of the nut 11 is inserted in the bearing 40. The flange 83 is in contact with the internal side of the spacer 80.

To rotate the nut 11 relative to the screw 82, a wrench (not shown) is engaged with the polygonal section 12 of the nut 11. The wrench is a socket wrench, a box-ended wrench, an open-ended wrench or a monkey wrench for example.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A tool comprising a nut and a bearing module, wherein the nut is engageable with a screw connected to a spacer to allow a hammer to hit the nut to remove the screw from the spacer, wherein the bearing module is located between the nut and the spacer to allow smooth rotation of the nut relative to the screw to extend the screw through the spacer, thereby connecting the screw to the spacer.

2. The screw-removing tool according to claim 1, wherein the nut includes a screw hole for receiving the screw and a bore for receiving a hammer.

3. The screw-removing tool according to claim 2, wherein the nut comprises a polygonal section for engagement with a wrench.

4. The screw-removing tool according to claim 3, wherein the bearing module comprises:
a shell comprising an aperture and a chamber in communication with the aperture, wherein the screw is extensible through the aperture and the chamber; and
a bearing located in the chamber and operable for contact with the nut.

5. The screw-removing tool according to claim 4, wherein the bearing module comprises a clip comprises a portion engaged with shell and another portion abutted against the bearing.

6. The screw-removing tool according to claim 4, wherein the nut comprises a reduced section insertable in the bearing.

7. The screw-removing tool according to claim 6, wherein the nut comprises an enlarged section formed between the reduced section and the polygonal section.
